(19) United States
(12) Patent Application Publication
(10) Pub. No.: US 2025/0252151 A1
(43) Pub. Date: Aug. 7, 2025

(54) DISTRIBUTED STOCHASTIC NONSMOOTH OPTIMIZATION METHOD BASED ON SMOOTHING AND MOMENTUM TECHNIQUES

(71) Applicant: BEIJING INSTITUTE OF TECHNOLOGY, Beijing (CN)

(72) Inventors: Xianlin ZENG, Beijing (CN); Jie HOU, Beijing (CN); Yuman HE, Beijing (CN); Shisheng CUI, Beijing (CN); Yi HUANG, Beijing (CN); Gang WANG, Beijing (CN); Lihua DOU, Beijing (CN); Jian SUN, Beijing (CN); Jie CHEN, Beijing (CN)

(73) Assignee: BEIJING INSTITUTE OF TECHNOLOGY, Beijing (CN)

(21) Appl. No.: 18/897,075

(22) Filed: Sep. 26, 2024

(30) Foreign Application Priority Data
Feb. 2, 2024 (CN) 202410149842.7

(51) Int. Cl. G06F 17/11

(52) U.S. Cl. CPC G06F 17/11

(57) ABSTRACT

A distributed stochastic nonsmooth optimization method based on smoothing and momentum techniques is provided. The distributed stochastic nonsmooth optimization method solves nonsmooth composite optimization problems with constraints and stochastic factors in a distributed manner and achieves a higher convergence rate, lower computational complexity, and lower storage overhead. The method includes: using a distributed algorithm based on smoothing and momentum techniques to process all the agents in a loop, and providing initial states, step sizes, recommended ranges of smoothing parameters, and so on of the algorithm; and specifying performance metrics of the algorithm, and depicting clustering comparison results according to the metrics. The method is applicable to composite optimization problems with nonsmooth terms, including but not limited to clustering problems, least absolute shrinkage and selection operator (LASSO) regression in machine learning and compressed sensing problems in sensor networks, and is applicable to large-scale distributed nonsmooth optimization scenarios with high-dimensional complex constraints.

### CROSS REFERENCE TO THE RELATED APPLICATIONS

This application is based upon and claims priority to Chinese Patent Application No. 202410149842.7, filed on Feb. 2, 2024, the entire contents of which are incorporated herein by reference.

### TECHNICAL FIELD

The present disclosure relates to the technical field of distributed optimization, and in particular, to a distributed stochastic nonsmooth optimization method based on smoothing and momentum techniques.

### BACKGROUND

Distributed optimization problems with set constraints and stochastic factors generally exist in various engineering applications, including unmanned systems, wireless communications, distributed machine learning, multi-agent reinforcement learning, and many other fields. Distributed optimization aims to minimize a global objective function through local computation and information exchange among agents. However, objective functions of many practical problems have a composite structure which often contains smooth and nonsmooth function parts. Such problems include least absolute shrinkage and selection operator (LASSO) regression and semidefinite programming (SDP) in machine learning and compressed sensing in sensor networks. Distributed stochastic optimization methods provide a solution to these large-scale composite optimization problems.

At present, a large number of distributed algorithms have been proposed to solve the distributed composite stochastic optimization problems or special cases thereof. One of the common approaches is to extend the subgradient algorithm into a distributed scheme to deal with nonsmooth optimization problems through the average consistency strategy or gradient tracking technique. Another typical approach is the proximal gradient descent algorithm, such as the proximal alternating direction method of multipliers (ADMM). It should be noted that both approaches require computation of projection operation. When the dimension of the problem is low, the computational complexity of the projection operation is acceptable. However, for some structured problems or high-dimensional problems, the cost of projecting onto a constraint set may be high.

Another approach to solve the optimization problems with constraint sets is the conditional gradient method, also known as the Frank-Wolfe (FW) algorithm. FW algorithm avoids the computation of projection operation by firstly solving a linear minimization subproblem on the constraint set to obtain a conditional gradient, and then updates the next iteration through a convex combination of the current iteration and the conditional gradient. In recent years, the FW algorithm has made significant progress in solving stochastic optimization problems with smooth or nonsmooth objective functions. For smooth objective functions, a stochastic conditional gradient method, that is, stochastic Frank-Wolfe (SFW) is proposed through a momentum-based variance reduction technique, and it is proved that this method converges to an optimal objective function value at a sublinear rate of

$$𝒪 ( {k}^{- \frac{1}{3}} ) .$$

For nonsmooth objective functions, a new FW variant, that is, stochastic homotopy conditional gradient method (SHCGM) is proposed to solve stochastic optimization problems with affine constraints, which guarantees an expected convergence rate of

$$𝒪 ( {k}^{- \frac{1}{3}} )$$

and a feasibility gap of

$$𝒪 ( {k}^{- \frac{5}{12}} ) .$$

It should be noted that the above FW algorithms and their variants are all performed in a centralized environment and cannot be directly applied to a distributed environment. Meanwhile, even in a centralized setting, the nonsmooth stochastic conditional gradient technique still cannot achieve the same convergence rate

$$𝒪 ( {k}^{- \frac{1}{2}} )$$

as the projection-based stochastic subgradient descent method.

However, how to solve the nonsmooth composite optimization problems with constraints and stochastic factors in a distributed manner while balancing factors such as convergence rate, computational complexity, and storage overhead is something that the existing solutions have not yet studied.

### SUMMARY

In view of the above, the present disclosure provides a distributed stochastic nonsmooth optimization method based on smoothing and momentum techniques. The method solves nonsmooth composite optimization problems with constraints and stochastic factors in a distributed manner and achieves a higher convergence rate, lower computational complexity, and lower storage overhead.

To achieve the above objective, the present disclosure provides the following technical solution. A distributed stochastic nonsmooth optimization method based on smoothing and momentum techniques is disclosed. For a multi-agent network, each of agents has an individual local objective function, and all the agents aim to find a common strategy for minimizing an average value of all the objective functions, the method is used to optimize and solve parameters of the agents and specifically includes the following steps:
step 1: performing, by the agents, weighted averaging on state values received from neighbors according to a weighted adjacency matrix of the multi-agent network to obtain an average state estimate;
step 2: obtaining, by the agents, stochastic gradients in each iteration, introducing recursive momentum into a distributed Frank-Wolfe algorithm, and constructing a local gradient iteration approximation;
step 3: estimating, by the agents, a global gradient using a gradient tracking technique; and
step 4: using a Frank-Wolfe step by the agents to compute a conditional gradient and update an iterate;
by performing the steps 1 to 4 iteratively until a number of iterations is greater than a set maximum value, all the agents obtain optimized parameter values.

Further, the multi-agent network is specifically:
a network [symbol] =( [symbol] , ε) including N agents [symbol] ={1, 2, . . . , N}, where ε represents a set of edges in the network [symbol] ;
each of the agents iε [symbol] has an individual local objective function Fᵢ(x)= [symbol] [fᵢ(x, ξⁱ)], where fᵢ is a stochastic function involving a strategic variable x∈ [symbol] ^{p} and a random variable ξⁱ with an unknown distribution, [symbol] ^{P} is a p-dimensional real number set;
a function G is a global convex function and has two forms: a Lipschitz continuous nonsmooth function or an indicator function related to a convex set [symbol] ;
the strategy to be found by all the agents and used for minimizing an average value of all the objective functions is denoted by x*, that is, x* is a solution or a problem

$${min}_{x ∈ 𝒳} F ( x ) := \frac{1}{N} {\sum }_{i = 1}^{N} {F}_{i} ( x ) + G ( Ax ) ,$$

where [symbol] is a compact convex feasible set and a linear mapping matrix A∈ [symbol] ^{q×n}, [symbol] _{q×n} is a q×n-dimensional real number set.

The method further includes initializing the following parameters before the step 1:
setting a maximum target number of iterations

$$K = 𝒪 ( \frac{1}{{ε}^{2}} ) ,$$

where ε is a predefined convergence error;
initializing the parameters of each of the agents i, that is, the parameters to be optimized x₁ⁱ∈ [symbol] , [symbol] is a feasible set;
initializing a local gradient g₁ⁱ=∇fᵢ(x̅₁ⁱ, ξ₁ⁱ), a first aggregated gradient being y₁ⁱ=g₁ⁱ, where i∈ [symbol] , [symbol] N={1, 2, . . . , N}; x̅₁ⁱ represents an average state estimate of the i^{th} agent in a first iteration, and ξ₁ⁱ represents a random variable of the i^{th} agent in the first iteration; and
setting a first step size ηₖ∈(0,1] and a second step size γₖ∈(0,1].

Further, the step 1 of performing, by the agents, the weighted averaging on the state values received from the neighbors according to the weighted adjacency matrix of the multi-agent network to obtain the average state estimate specifically includes:
computing, by the i^{th} agent, the average state estimate x̅ₖⁱ=Σ_{j∈Ni}wᵢⱼxₖ^{j} and saving the corresponding data x̅ₖⁱ in a storage space of the i^{th} agent, where [symbol] represents a neighbor set of the i^{th} agent, wᵢⱼ represents an adjacency weight between the i^{th} agent and a j^{th} agent, the weighted adjacency matrix W=[wᵢⱼ]_{N×N} is a doubly stochastic matrix, and k is the number of iterations.

Further, the step 2 of obtaining, by the agents, the stochastic gradients in the each iteration, introducing the recursive momentum into the distributed Frank-Wolfe algorithm, and constructing the local gradient iteration approximation specifically includes:
the constructed local gradient iteration approximation being:

$${g}_{k}^{i} = ( 1 - {η}_{k} ) {g}_{k - 1}^{i} + ∇ {f}_{i} ( {\overline{x}}_{k}^{i} , {ξ}_{k}^{i} ) - ( 1 - {η}_{k} ) ∇ {f}_{i} ( {\overline{x}}_{k - 1}^{i} , {ξ}_{k}^{i} ) ,$$

where gₖⁱ is an estimated local gradient of the i^{th} agent in a k^{th} iteration and ηₖ ∈(0,1] is the first step size of the iteration; and
after computing gₖⁱ, saving the corresponding data gₖⁱ in the storage space of the i^{th} agent.

Further, the step 3 of estimating, by the agents, the global gradient using the gradient tracking technique specifically includes:
repeatedly using, by the i^{th} agent, a first aggregated gradient yₖ₋₁ⁱ obtained in a (k−1)^{th} iteration to get yₖⁱ= [symbol] wᵢⱼyₖ₋₁^{j}+gₖⁱ−gₖ₋₁, sₖⁱ= [symbol] wᵢⱼ yₖ^{j} based on the gradient tracking technique, where yₖⁱ is a first aggregated gradient of the i^{th} agent in the k^{th} iteration, sₖⁱ is a second aggregated gradient of the i^{th} agent in the k^{th} iteration, and wᵢⱼ represents the adjacency weight between the i^{th} agent and the j^{th} agent;
the estimated global gradient being vₖⁱ=sₖⁱ+βₖ⁻¹A^{T} (Ax̅ₖⁱ−prox_{βk,G}(Ax̅ₖⁱ), where βₖ is a smoothing parameter in the k^{th} iteration and a proximal operator

$${prox}_{{β}_{k} , G} ( A {\overline{x}}_{k}^{i} ) = arg {min}_{z ∈ 𝒳} \{ G ( z ) + \frac{1}{2 {β}_{k}} {‖ A {\overline{x}}_{k}^{i} - z ‖}^{2} \} .$$

Further, the step 4 of using the Frank-Wolfe step by the agents to compute the conditional gradient and update the iterate specifically includes:
a conditional gradient of the i^{th} agent in the k^{th} iteration being zₖⁱ∈

$${arg min}_{ϕ ∈ 𝒳} 〈 {v}_{k}^{i} , ϕ 〉 ;$$

updating the iterate xₖ₊₁ⁱ=x̅ₖⁱ+γₖ(zₖⁱ−x̅ₖⁱ), where γₖε(0,1] is the second step size of the iteration.

The present disclosure has the following advantages.

Compared with the prior art, the stochastic nonsmooth optimization method based on the smoothing and momentum techniques provided by the present disclosure utilizes a distributed computation mode, that is, multiple agents collaborate for global optimization through local computation and information exchange with neighbors. It achieves lower storage burden, higher privacy protection, and higher scalability than the centralized computation mode. Moreover, only a small number of samples need to be randomly selected for gradient computation in each iteration, and there is no need to compute gradients for all the samples or batches of samples. Therefore, it is more suitable for high-dimensional and large-scale optimization problems. The method solves nonsmooth composite optimization problems with in constraints and stochastic factors in a distributed manner and achieves better computational efficiency, a higher convergence rate, and lower storage cost.

### BRIEF DESCRIPTION OF THE DRAWINGS

FIG. 1 is a flow chart of the proposed algorithm for a k-means clustering problem.

FIG. 2 shows test results of the proposed algorithm for the k-means clustering problem.

### DETAILED DESCRIPTION OF THE EMBODIMENTS

The present disclosure will be described in detail below through embodiments with reference to the accompanying drawings.

Distributed optimization problems with constraints and stochastic factors generally exist in various engineering applications. The objective functions of many practical problems have a composite structure which often contains smooth and nonsmooth parts. Such problems include the LASSO regression problem and the SDP problem in machine learning and the compressed sensing problem in sensor networks. Distributed stochastic optimization algorithms provide a solution to these composite structure optimization problems. At present, most algorithms for dealing with nonsmooth optimization problems are based on proximal operators or subgradient techniques. The existence of projection operations will cause computational bottlenecks of these algorithms in high-dimensional or complex constraint situations. Besides, most algorithms are only applicable to situations with a determined environment and cannot be directly used in stochastic optimization problems.

The present disclosure mainly utilizes the Frank-Wolfe algorithm framework and the smoothing method to deal with composite optimization problems with nonsmooth terms, thereby avoiding costly computation of projection operation. Meanwhile, this method uses a momentum-based variance reduction technique to deal with the nonvanishing gradient variance caused by stochastic factors, which can accelerate the algorithm while ensuring its convergence.

The present disclosure is directed to a multi-agent network, where each of agents has an individual local objective function. All the agents aim to find a common strategy for minimizing an average value of all the objective functions. The distributed stochastic optimization method based on the smoothing and momentum techniques is used to optimize and solve parameters of the agents.

An embodiment of the present disclosure concerns a network with N agents. All the agents collaborate to solve, through local computation and information exchange with neighbors, an optimization problem which is expressed as:

$${min}_{x ∈ 𝒳} F ( x ) := \frac{1}{N} {\sum }_{i = 1}^{N} {F}_{i} ( x ) + G ( Ax ) ,$$

where Fᵢ(x)= [symbol] [fᵢ(x, ξⁱ)] is a local objective function of an agent i, fᵢ is a stochastic function involving a strategic variable x and a random variable ξⁱ with an unknown distribution, [symbol] ⊆ [symbol] ⁿ is a compact convex feasible set and is difficult to project onto, and A∈ [symbol] ^{q×n}. The function G is a global convex function (possibly nonsmooth) and it has two main forms:
1. G(·) is a Lipschitz continuous nonsmooth function.
2. G(·) is an indicator function with a convex set y:

$$G ( y ) := \{ \begin{matrix}0 , & if y ∈ 𝒴 \\ + ∞ , & otherwise\end{matrix} ,$$

where the variables are easily projected onto the set y.

For the network with N agents, the following network model is built: An undirected network [symbol] :=(N,ε) is defined, where N={1, 2, . . . , N} is a set of agents and ε=N×N is a set of edges. W=[wᵢⱼ]_{N×N} is a weighted adjacency matrix of the graph [symbol] , and for any ∀i,j ∈N, if (i, j)∈ε, wᵢⱼ>0; otherwise, wᵢⱼ=0. The weighted adjacency matrix W is a doubly stochastic matrix.

The network model has the following characteristics:
1. The topology network [symbol] is connected;
2. The weighted adjacency matrix W is a doubly stochastic matrix, that is, Σᵢ₌₁^{N}wᵢⱼ=Σⱼ₌₁^{N}wᵢⱼ=1;
3. For any i∈ [symbol] and ξⁱ∈ [symbol] ^{p}, ξⁱ(·) and fᵢ (·, ξⁱ) are L_{f}-smooth in the constraint set [symbol] ;
4. The feasible set [symbol] is a compact convex set;
5. There exists a constant δ to make [symbol] [∥∇fᵢ(x,ξⁱ)−∇Fᵢ(x)∥²|x]≤δ²;
6. The distributed stochastic optimization problem with an indicator function satisfies the Slater's condition, that is, relint( [symbol] × [symbol] )∩{(x, r)∈ [symbol] ⁿ× [symbol] ^{q}: Ax=r}≠∅, where relint ( [symbol] × [symbol] ) represents a relatively feasible interior set of the set [symbol] × [symbol] .

To solve the above problem, the present disclosure provides a distributed stochastic Frank-Wolfe algorithm with the smoothing and the momentum-based variance reduction technique, also known as distributed stochastic momentum-based Frank-Wolfe algorithm (DSMO-FW).

To measure the performance of DSMO-FW, a stochastic first-order Oracle (SFO) is introduced in the present disclosure. For a specified x∈ [symbol] ⁿ, SFO returns an estimated gradient ∇fᵢ(x, ξⁱ).

The embodiment of the present disclosure specifically includes the following steps.

Step 1: The agents perform weighted averaging on state values received from neighbors according to a weighted adjacency matrix of the multi-agent network to obtain an average state estimate.

In the embodiment of the present disclosure, the agent i performs weighted averaging on the state values received from the neighbors according to the weighted adjacency matrix W, that is, x̅ₖⁱ= [symbol] wᵢⱼxₖ^{j} is used to approximate the average iteration, where [symbol] represents a neighbor set of the i^{th} agent and wᵢⱼ represents an adjacency weight between the i^{th} agent and the j^{th} agent.

Step 2: The agents obtain stochastic gradients in each iteration, introduce recursive momentum into a distributed Frank-Wolfe algorithm, and construct a local gradient iteration approximation.

In the embodiment of the present disclosure, the agent i obtains a stochastic gradient ∇fᵢ(xₖⁱ, ξⁱ) in the k^{th} iteration. The present disclosure introduces an improved momentum-based variance reduction method (recursive momentum) into a distributed stochastic Frank-Wolfe (FW) algorithm to solve the nonvanishing variance caused by gradient estimation. The specific expression is as follows:

$${g}_{k}^{i} = ( 1 - {η}_{k} ) {g}_{k - 1}^{i} + ∇ {f}_{i} ( {\overline{x}}_{k}^{i} , {ξ}_{k}^{i} ) - ( 1 - {η}_{k} ) ∇ {f}_{i} ( {\overline{x}}_{k - 1}^{i} , {ξ}_{k}^{i} ) ,$$

where ηₖ ∈(0,1].

Step 3: The agents estimate a global gradient using a gradient tracking technique.

In the embodiment of the present disclosure, the agent i estimates the global gradient.

Firstly, the estimate yₖ₋₁ⁱ obtained in the previous iteration is repeatedly used to get sₖⁱ based on the gradient tracking technique. Then, sₖⁱ is combined with the gradient of G_{β}_{ₖ}(Ax̅ₖⁱ) to obtain the global gradient estimate vₖⁱ. The process can be specifically expressed as:

$$\begin{matrix}{y}_{k}^{i} & = {\sum }_{j ∈ {𝒩}_{i}} {w}_{ij} {y}_{k - 1}^{j} + {g}_{k}^{i} - {g}_{k - 1}^{i} , \\ {s}_{k}^{i} & = {\sum }_{j ∈ {𝒩}_{i}} {w}_{ij} {y}_{k}^{j} , \\ {v}_{k}^{i} & = {s}_{k}^{i} + {β}_{k}^{- 1} {A}^{T} ( A {\overline{x}}_{k}^{i} - {prox}_{{β}_{k} , G} ( A {\overline{x}}_{k}^{i} ) ) ,\end{matrix}$$

where prox is a proximal operator and its computation formula is

$${prox}_{β , h} ( x ) = arg {min}_{z ∈ 𝒳} \{ h ( z ) + \frac{1}{2 β} {‖ x - z ‖}^{2} \} .$$

Step 4: The agents use a Frank-Wolfe step to compute a conditional gradient and update an iterate.

In the embodiment of the present disclosure, the agent i needs update and iteration to avoid computation of projection operation. The conditional gradient zₖⁱ is obtained by solving the linear minimization problem, and the next iteration xₖ₊₁ⁱ is expressed as a convex combination of x̅ₖⁱ and zₖⁱ. The specific update and iteration process is as follows:

$${z}_{k}^{i} ∈ {arg min}_{ϕ ∈ 𝒳} 〈 {v}_{k}^{i} , ϕ 〉 , \\ {x}_{k + 1}^{i} = {\overline{x}}_{k}^{i} + {γ}_{k} ( {z}_{k}^{i} - {\overline{x}}_{k}^{i} ) ,$$

where γₖ ∈(0,1] is a step size.

The steps 1 to 4 are performed iteratively until a number of iterations is greater than a set maximum value, so that all the agents obtain optimized parameter values.

The present disclosure introduces an improved momentum-based variance reduction method to solve the nonvanishing variance caused by gradient estimation. This design reduces the variance of the gradient while ensuring its convergence. It can be seen from the local gradient iteration approximation that the method proposed in this patent only needs a small number of samples (as small as one sample) for gradient computation in each iteration process to ensure the convergence of the algorithm. Meanwhile, the method proposed in this patent does not need to store the gradient information of each sample, and it only needs to store the local gradient computed in the current iteration for use in the next iteration. Compared with large batch-size or deterministic gradient descent methods, the proposed method greatly reduces the computational complexity and the storage overhead.

Table 1 shows the comparison of the optimality gap and the feasibility gap between the proposed distributed stochastic momentum-based Frank-Wolfe algorithm (DSMO-FW), the centralized smooth stochastic algorithms (SFW, 1-SFW), and the centralized stochastic optimization algorithm (SHCGM).

TABLE 1

| | | Nonsmooth function | | | |
|---|---|---|---|---|---|
| | | Lipschitz | | | |
| | | continuous | | | |
| | Applicable | regularization | Indicator | Optimality | Feasibility |
| Name of algorithm | environment | term | function | gap | gap |
| Stochastic homotopy conditional gradient | Centralized | ✓ | ✓ | $𝒪 ( {k}^{- \frac{1}{3}} )$ | $𝒪 ( {k}^{- \frac{5}{12}} )$ |
| method (SHCGM) | | | | | |
| Stochastic Frank-Wolfe method (SFW) | Centralized | x | x | $𝒪 ( {k}^{- \frac{1}{3}} )$ | — |
| One-sample stochastic Frank-Wolfe | Centralized | x | x | $𝒪 ( {k}^{- \frac{1}{2}} )$ | — |
| method (1-SFW) | | | | | |
| DSMO-FW (the method of the present disclosure) | Distributed | ✓ | ✓ | $𝒪 ( {k}^{- \frac{1}{2}} )$ | $𝒪 ( {k}^{- \frac{1}{2}} )$ |

The present disclosure utilizes the momentum-based variance reduction technique to eliminate the nonvanishing gradient variance caused by stochastic factors, thereby accelerating the algorithm while ensuring its convergence. Apparently, the method proposed in this patent has a higher convergence rate than the other nonsmooth methods.

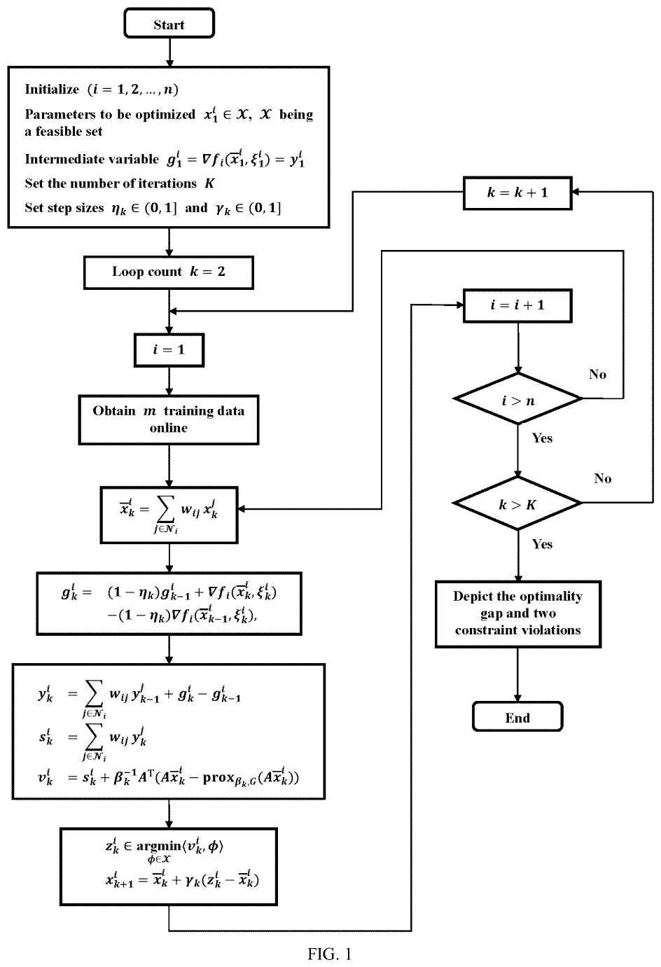

Referring to FIG. 1, the specific implementation of the present disclosure is described in detail below by taking k-means clustering learning on a public data set MNIST as an example.

SDP formulas concerning the k-means clustering problem are:

$${min}_{x ∈ 𝒳} \{ F ( X ) := \frac{1}{N} {\sum }_{i = 1}^{N} {F}_{i} ( X ) \} ,$$

s.t.G:={X∈ [symbol] ^{n×n}|X1ₙ=1ₙ, X≥0_{n×n}}, where

$${F}_{i} ( X ) := \frac{1}{\vert {Ω}_{i} \vert} {\sum }_{[ l , h ] ∈ {Ω}_{i}}$$

[M]_{l,h}, [X]_{l,h}, X={X∈ [symbol] ₊ⁿ, tr(X)≤α}; 1ₙ is an n-dimensional vector with all elements being 1; 0_{n×n} is an n×n-dimensional matrix with elements 0; the set Ωᵢ satisfies [symbol] ⊇Ω=∪ᵢ₌₁^{N}=Ωᵢ and [symbol] : ={(i, j)|1≤i, j≤N}; and the matrix M is a Euclidean distance matrix.

Two performance indicators: optimality gap and constraint violation are introduced to test the performance of the algorithm. The optimality gap is defined as |F(X)−F(X*)|/|F(X*)|, where F(X*) is an optimal value. The constraint violations of two constraints are defined as ∥ X1ₙ−1ₙ∥/∥1ₙ∥ and ∥X−proj_{x≥0}_{_{n×n}}(X)∥_{F}, respectively.

Before the algorithm is executed, the present disclosure preprocesses the data set. The dataset MNIST consists of 70,000 different 28×28 grayscale images, which are reshaped into a 784×1-dimensional vector. Feature extraction is required first to obtain better clustering results. The present disclosure is implemented by using a single-layer neural network y(α)=σ(Wα+b), where σ is a softmax function, W is a 784×10-dimensional matrix for learning, and b is a 10×1-dimensional vector for learning. The neural network is trained for 1000 iterations, with each iteration using 100 random sample data from the training set as batch input. Then, the trained neural network is run on the first 1000 elements of the test set to obtain {y(aᵢ)}=ᵢ₌₁¹⁰⁰⁰ with a total of 1000 samples, where each y(a₁) is a 10×1-dimensional vector representing the probability of classifying the sample aᵢ into different categories. M_{1000×10} is a 1000×10-dimensional matrix obtained from the trained data, and the (i, j)^{th} element in M is expressed as

$${M}_{ij} = {‖ {a}_{i} - \frac{{{\sum }_{l = 1}^{1000} [ y ( {a}_{l} ) ]}_{j} {a}_{l}}{{{\sum }_{l = 1}^{1000} [ y ( {a}_{l} ) ]}_{j}} ‖}^{2} .$$

The number of agents is set to 10, the training set is evenly divided into 10 parts for these agents, and each agent randomly selects 1% of the data in the training set. That is, only part of the sample information can be obtained randomly in each iteration, and it is impossible to know all the sample information.

The parameters to be optimized are set to X₁ⁱ∈ [symbol] and the local gradient is g₁ⁱ=∇Fᵢ(X̅₁ⁱ, ξ₁ⁱ)=y₁ⁱ, where i=1,2, . . . ,10. The total number of iterations is set to K=10⁵, the step sizes are ηₖ=2/(k+1) and γₖ=2/(k+2), and the smoothing parameter βₖ=β₀/(k+2)^{1/2} is adjusted, where β₀=10 and k represents the current number of iterations. The present disclosure selects a decay step size, that is, the step size gradually decreases as the number of iterations increases. In practice, if the test results do not diverge, the step size can be appropriately increased to speed up the computation.

The 1^{st}, 2^{nd}, . . . , and K^{th} iterations are performed for all the agents. Each agent randomly selects 1% of the data in the training set for training in each iteration. After completing one iteration for all the agents, the data Xₖ₊₁ⁱ, gₖⁱ, sₖⁱ, yₖⁱ, and vₖⁱ of each agent in the current iteration are saved, and then the next iteration is performed with k=k+1.

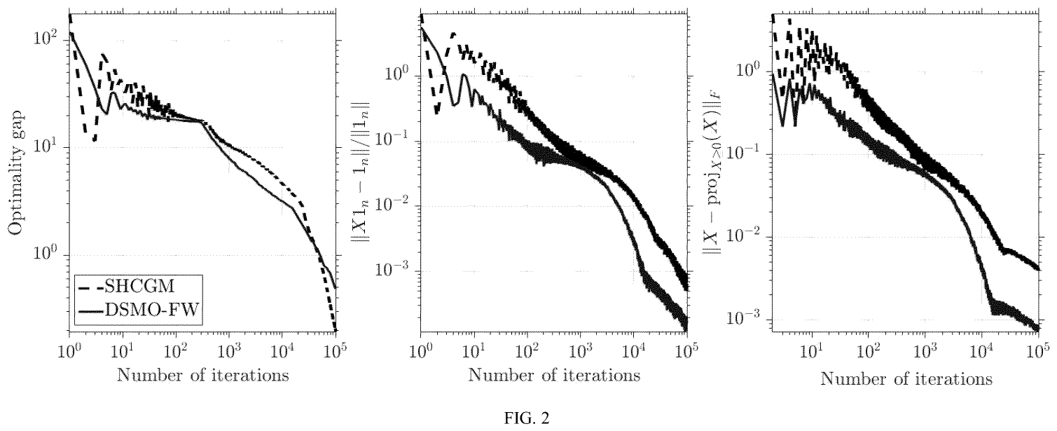

After 10⁵ iterations, the optimality gap of the DSMO-FW algorithm (compared with the SHCGM algorithm) is depicted in FIG. 2.

The convergence verification process of this method is described in detail below.

1. Convergence analysis of stochastic optimization with a Lipschitz continuous regularization term

The present disclosure defines the following auxiliary variables:

$${\overline{x}}_{k} := \frac{1}{N} {\sum }_{i = 1}^{N} {x}_{k}^{i} , \\ {\overline{x}}_{k}^{i} := {\sum }_{j = 1}^{N} {w}_{ij} {x}_{k}^{j} , \\ {\overline{g}}_{k} := \frac{1}{N} {\sum }_{i = 1}^{N} {g}_{k}^{i} , and \\ {\overline{p}}_{k} := \frac{1}{N} {\sum }_{i = 1}^{N} ∇ {F}_{i} ( {\overline{x}}_{k}^{i} ) .$$

x̅ₖ represents the average state of all the agents in the network, x̅ₖⁱ represents the estimated average state of the agent i, g̅ₖ represents the estimated average local gradient of all the agents in the network, and p̅ₖ represents the true average gradient of all the agents. Before providing proof of the convergence rate, the present disclosure introduces the following lemmas.

Lemma 1: Assume that the Assumptions 1, 2, 4 are valid. When

$${γ}_{k} = \frac{2}{k + 2} ,$$

for any i ∈ [symbol] and k≥1,

$$‖ {\overline{x}}_{k}^{i} - {\overline{x}}_{k} ‖ \leq \frac{2 {C}_{1}}{k + 2}$$

$$‖ {\overline{x}}_{k + 1}^{i} - {\overline{x}}_{k}^{i} ‖ \leq \frac{2 ( d + 2 {C}_{1} )}{k + 2} ,$$

where C₁=k₀\sqrt{N}d.

The Lemma 1 shows that the average iteration estimate xx approaches the average value x̅ₖ at a rate of [symbol] (γₖ), which means that when k→+∞, the local estimates of the agents in the network [symbol] achieve consistency, that is, as the number of iterations increases, the average state estimate of the agent i tends to the true state average.

Lemma 2: The step sizes

$${η}_{k} = \frac{2}{k + 1} , {γ}_{k} = \frac{2}{k + 2}$$

and the time decay sequence

$$0 < {ρ}_{k} \leq \frac{d + 2 {C}_{1}}{\sqrt{n} ( k + 2 )}$$

are selected, and according to the Assumptions 1 to 5, for any i∈ [symbol] and k≥1,

$$𝔼 [ {‖ {\overline{g}}_{k} - {s}_{k}^{i} ‖}^{2} ] \leq \frac{4 {C}_{2}}{{( k + 2 )}^{2}} ,$$

where C₂=k₀³4^{ko-1}N(54L_{f}²(d+2C₁)²⁺¹²⁽²l²+ψ₂)).

The present disclosure introduces the following lemma to prove the convergence of the algorithm.

Lemma 3: Assume that Assumptions 1 to 5 are valid.
a) For any k≥1, the expectation of ∥g̅ₖ−h̅ₖ∥² satisfies:

$$𝔼 [ {‖ {\overline{g}}_{k} - {\overline{h}}_{k} ‖}^{2} ] \leq {( 1 - {η}_{k} )}^{2} 𝔼 [ {‖ {\overline{g}}_{k - 1} - {\overline{h}}_{k - 1} ‖}^{2} ] + 76 {nL}_{f}^{2} {ρ}_{k - 1}^{2} + 6 {δ}^{2} {η}_{k}^{2} + 16 {{L}_{f}^{2} ( d + 2 {C}_{1} )}^{2} {γ}_{k - 1}^{2} ;$$

b) The step sizes

$${η}_{k} = \frac{2}{k + 1} , {γ}_{k} = \frac{2}{k + 2}$$

and the time decay sequence

$$0 < {ρ}_{k} \leq \frac{d + 2 {C}_{1}}{\sqrt{n} ( k + 2 )}$$

are selected, so that

$$𝔼 [ {‖ {\overline{g}}_{k} - {\overline{p}}_{k} ‖}^{2} ] \leq \frac{2 {C}_{3} + 2 {{L}_{f}^{2} ( d + 2 {C}_{1} )}^{2}}{k + 2} ,$$

where C₃:=max{2∥g̅₁−h̅₁∥², 140L_{f}²(d+2C₁)²+24δ²}.

The Lemma 3 shows that the gradient estimate g̅ₖ approaches the average gradient p̅ₖ with an expected margin of error of

$$𝒪 ( \frac{{C}_{3} + {{L}_{f}^{2} ( d + {C}_{1} )}^{2}}{k + 2} ) .$$

It means that the noises caused by stochastic gradient estimation decrease with the increase of the number of iterations in the DSMO-FW algorithm. The present disclosure leads to the following lemma based on Lemma 2 and Lemma 3.

Lemma 4: Assume that Assumptions 1 to 5 are valid. If and the time decay sequence

$${η}_{k} = \frac{2}{k + 1} , {γ}_{k} = \frac{2}{k + 2} ,$$

and the time decay sequence

$$0 < {ρ}_{k} \leq \frac{d + 2 {C}_{1}}{\sqrt{n} ( k + 2 )} ,$$

for any i∈ [symbol] and k≥1,

$$𝔼 [ {‖ ∇ \overline{F} ( {\overline{x}}_{k} ) - {s}_{k}^{i} ‖}^{2} ] \leq \frac{18 {{L}_{f}^{2} ( d + 2 {C}_{1} )}^{2} + 12 {C}_{2} + 6 {C}_{3}}{k + 2} .$$

The present disclosure obtains the following convergence theorems according to Lemma 4.

Theorem 1: If

$${η}_{k} = \frac{2}{k + 1} , {β}_{k} = {β}_{0} / {( k + 2 )}^{\frac{1}{2}} ( {β}_{0} > 0 ) , {γ}_{k} = \frac{2}{k + 2} ,$$

and the time decay sequence

$$0 < {ρ}_{k} \leq \frac{d + 2 {C}_{1}}{\sqrt{n} ( k + 2 )} ,$$

according to Assumptions 1 to 5, for any k≥1,

$$𝔼 [ {F}_{{β}_{k}} ( {\overline{x}}_{k + 1} ) ] - F ( {x}^{*} ) \leq \frac{{C}_{4}}{{( k + 3 )}^{\frac{1}{2}}} ,$$

where C₄:=max {\sqrt{3}(F_{β}_{₀}(x̅₁̅)−F(x*)), 2d²L_{f}+36L_{f}²d(d+2C₁)²+12d(2C₂+C₃)+∥A∥²d²β₀⁻¹(2+16C₁)}.

Theorem 1 shows that the optimality gap [symbol] [F_{β}_{ₖ}(x̅ₖ₊₁)]−F(x*) of the smooth function F_{β}_{ₖ} is bounded by [symbol] (k^{-1/2}), which means that DSMO-FW achieves the sublinear convergence rate of [symbol] (k^{-1/2}). Therefore, the present disclosure can deduce the optimality gap of DSMO-FW to solve the distributed composite stochastic optimization problem in the following theorem.

Theorem 2: Assume that G: [symbol] ^{p}→ [symbol] is an L_{g}-Lipschitz continuous regularization term. If

$${η}_{k} = \frac{2}{k + 1} , {β}_{k} = {β}_{0} / {( k + 2 )}^{\frac{1}{2}} ( {β}_{0} > 0 ) , {γ}_{k} = \frac{2}{k + 2} ,$$

and the time decay sequence

$$0 < {ρ}_{k} \leq \frac{d + 2 {C}_{1}}{\sqrt{n} ( k + 2 )} ,$$

according to Assumptions 1 to 5, for any k≥1,

$$𝔼 [ F ( {\overline{x}}_{k + 1} ) ] - F ( {x}^{*} ) \leq \frac{{C}_{4} + {L}_{g}^{2} {β}_{0}}{{( k + 2 )}^{\frac{1}{2}}} .$$

Theorem 2 shows that DSMO-FW converges at a rate of [symbol] (k^{-1/2}) for the distributed composite stochastic optimization problem with the Lipschitz continuous regularization term. This result can be directly translated into the Oracle complexity required to find the ϵ-optimal solution. For SFO, the total number of calls required is

$$𝒪 ( \frac{{( {C}_{4} + {L}_{g}^{2} {β}_{0} )}^{2}}{{ϵ}^{2}} ) .$$

Several lemmas need to be provided before proving Theorem 1 and Theorem 2.

Lemma 5: If the real number sequence {Πₖ} satisfies

$${\prod }_{k} = ( 1 - \frac{{A}_{1}}{{( k + {t}_{0} )}^{{a}_{1}}} ) {\prod }_{k - 1} + \frac{{A}_{2}}{{( k + {t}_{0} )}^{{a}_{2}}} ,$$

where a₁∈[0,1], a₁≤a₂≤2a₁, A₁>1, and A_{2≥0}. The rate at which {Πₖ} converges to zero is

$${\prod }_{k} \leq \frac{A}{{( k + {t}_{0} + 1 )}^{{a}_{2} - {a}_{1}}} ,$$

where

$$A = max \{ {\prod }_{0} {( {t}_{0} + 1 )}^{{a}_{2} - {a}_{1}} , \frac{{A}_{2}}{{A}_{1} - 1} \} .$$

Lemma 6: Assume that Assumption 1 is valid. For any k=1, 2, . . . , K, the following relationships are established:

$$\frac{1}{N} {\sum }_{i = 1}^{N} {y}_{k + 1}^{i} = {\overline{g}}_{k + 1} ; \qquad ( a )$$

$${\overline{x}}_{k + 1} = ( 1 - {γ}_{k} ) {\overline{x}}_{k} + {γ}_{k} {\overline{z}}_{k} , where {\overline{z}}_{k} = \frac{1}{N} {\sum }_{i = 1}^{N} {z}_{k}^{i} . \qquad ( b )$$

Lemma 7: Assume that the Assumptions 1, 2, 4 are valid. For any i E {1, 2, . . . , N} and k≥1,

$$〈 ∇ {F}_{{β}_{k}} ( {\overline{x}}_{k} ) , {z}_{k}^{i} - {\overline{x}}_{k} 〉 \leq ‖ ∇ \overline{F} ( {\overline{x}}_{k} ) - {s}_{k}^{i} ‖ d + \overline{F} ( {x}^{*} ) - \overline{F} ( {\overline{x}}_{k} ) + G ( A {x}^{*} ) - {G}_{{β}_{k}} ( A {\overline{x}}_{k} ) - \frac{{β}_{k}}{2} {‖ {u}_{{β}_{k}}^{*} ( A {\overline{x}}_{k} ) ‖}^{2} + 4 {C}_{1} {‖ A ‖}^{2} d {β}_{k}^{- 1} {γ}_{k} .$$

The proof of Theorem 1 is given as follows.

Proof: It can be obtained from (L_{f}+∥A∥²/β)-smoothness of the function F_{β} that

$$\begin{matrix}{F}_{{β}_{k}} ( {\overline{x}}_{k + 1} ) \leq {F}_{{β}_{k}} ( {\overline{x}}_{k} ) + 〈 ∇ {F}_{{β}_{k}} ( {\overline{x}}_{k} ) , {\overline{x}}_{k + 1} - {\overline{x}}_{k} 〉 + \\ \frac{1}{2} {‖ {\overline{x}}_{k + 1} - {\overline{x}}_{k} ‖}^{2} ( {L}_{f} + \frac{{‖ A ‖}^{2}}{{β}_{k}} ) \\ = {F}_{{β}_{k}} ( {\overline{x}}_{k} ) + {γ}_{k} 〈 ∇ {F}_{{β}_{k}} ( {\overline{x}}_{k} ) , {\overline{z}}_{k} - {\overline{x}}_{k} 〉 + \\ \frac{{γ}_{k}^{2}}{2} {‖ {\overline{z}}_{k} - {\overline{x}}_{k} ‖}^{2} ( {L}_{f} + \frac{{‖ A ‖}^{2}}{{β}_{k}} ) \\ \leq {F}_{{β}_{k}} ( {\overline{x}}_{k} ) + \frac{{γ}_{k}}{N} {\sum }_{i = 1}^{N} 〈 ∇ {F}_{{β}_{k}} ( {\overline{x}}_{k} ) , {z}_{k}^{i} - {\overline{x}}_{k} 〉 + \\ \frac{{γ}_{k}^{2}}{2} {d}^{2} ( {L}_{f} + \frac{{‖ A ‖}^{2}}{{β}_{k}} )\end{matrix} ,$$

where the equation is derived from Lemma 6-(b). The result of Lemma 7 is substituted into the above formula to get

$$\begin{matrix}{F}_{{β}_{k}} ( {\overline{x}}_{k + 1} ) \leq {F}_{{β}_{k}} ( {\overline{x}}_{k} ) + {γ}_{k} ( \overline{F} ( {x}^{*} ) - \overline{F} ( {\overline{x}}_{k} ) + G ( {Ax}^{*} ) - {G}_{{β}_{k}} ( A {\overline{x}}_{k} ) - \\ \frac{{β}_{k}}{2} {‖ {u}_{{β}_{k}}^{*} ( A {\overline{x}}_{k} ) ‖}^{2} ) + 4 {C}_{1} {‖ A ‖}^{2} d {β}_{k}^{- 1} {γ}_{k}^{2} + \\ \frac{{γ}_{k}}{N} {\sum }_{i = 1}^{N} ‖ ∇ \overline{F} ( {\overline{x}}_{k} ) - {s}_{k}^{i} ‖ d + \frac{{γ}_{k}^{2}}{2} {d}^{2} ( {L}_{f} + \frac{{‖ A ‖}^{2}}{{β}_{k}} ) \\ = ( 1 - {γ}_{k} ) {F}_{{β}_{k}} ( {\overline{x}}_{k} ) + {γ}_{k} F ( {x}^{*} ) - \frac{{γ}_{k} {β}_{k}}{2} {‖ {u}_{{β}_{k}}^{*} ( A {\overline{x}}_{k} ) ‖}^{2} + \\ \frac{{γ}_{k}}{N} {\sum }_{i = 1}^{N} ‖ ∇ \overline{F} ( {\overline{x}}_{k} ) - {s}_{k}^{i} ‖ d + \frac{{γ}_{k}^{2}}{2} {d}^{2} ( {L}_{f} + \frac{{‖ A ‖}^{2}}{{β}_{k}} ) + \\ 4 {C}_{1} {‖ A ‖}^{2} d {β}_{k}^{- 1} {γ}_{k}^{2}\end{matrix} .$$

It can be obtained from

$${G}_{{β}_{k}} ( A {\overline{x}}_{k} ) \leq {G}_{{β}_{k - 1}} ( A {\overline{x}}_{k} ) + \frac{{β}_{k - 1} - {β}_{k}}{2} ‖ {u}_{{β}_{k}}^{*} ( A {\overline{x}}_{k} ) ‖$$

that

$$\begin{matrix}{F}_{{β}_{k}} ( {\overline{x}}_{k} ) = \overline{F} ( {\overline{x}}_{k} ) + {G}_{{β}_{k}} ( A {\overline{x}}_{k} ) \\ \leq \overline{F} ( {\overline{x}}_{k} ) + {G}_{{β}_{k - 1}} ( A {\overline{x}}_{k} ) + \frac{{β}_{k - 1} - {β}_{k}}{2} ‖ {u}_{{β}_{k}}^{*} ( A {\overline{x}}_{k} ) ‖ \\ = {F}_{{β}_{k - 1}} ( {\overline{x}}_{k} ) + \frac{{β}_{k - 1} - {β}_{k}}{2} ‖ {u}_{{β}_{k}}^{*} ( A {\overline{x}}_{k} ) ‖\end{matrix} .$$

The above inequality is substituted into the previous inequality and F(x*) is subtracted from both sides of the inequality to get

$$\begin{matrix}{F}_{{β}_{k}} ( {\overline{x}}_{k + 1} ) - F ( {x}^{*} ) \leq ( 1 - {γ}_{k} ) ( {F}_{{β}_{k - 1}} ( {\overline{x}}_{k} ) - F ( {x}^{*} ) ) + \\ \frac{( 1 - {γ}_{k} ) ( {β}_{k - 1} - {β}_{k} ) - {γ}_{k} {β}_{k}}{2} ‖ {u}_{{β}_{k}}^{*} ( A {\overline{x}}_{k} ) ‖ + \\ \frac{{γ}_{k}}{N} {\sum }_{i = 1}^{N} ‖ ∇ \overline{F} ( {\overline{x}}_{k} ) - {s}_{k}^{i} ‖ d + \frac{{γ}_{k}^{2}}{2} {d}^{2} ( {L}_{f} + \frac{{‖ A ‖}^{2}}{{β}_{k}} ) + \\ 4 {C}_{1} {‖ A ‖}^{2} d {β}_{k}^{- 1} {γ}_{k}^{2}\end{matrix} .$$

If

$${γ}_{k} = \frac{2}{k + 2} and {β}_{k} = {β}_{0} / {( k + 2 )}^{\frac{1}{2}} ,$$

it is observed that (1−γₖ)(βₖ₋₁−βₖ)−γₖβₖ≤0

$$\begin{matrix}{F}_{{β}_{k}} ( {\overline{x}}_{k + 1} ) - F ( {x}^{*} ) \leq ( 1 - {γ}_{k} ) ( {F}_{{β}_{k - 1}} ( {\overline{x}}_{k} ) - F ( {x}^{*} ) ) + \\ \frac{{γ}_{k}}{N} {\sum }_{i = 1}^{N} ‖ ∇ \overline{F} ( {\overline{x}}_{k} ) - {s}_{k}^{i} ‖ d + \frac{{γ}_{k}^{2}}{2} {d}^{2} ( {L}_{f} + \frac{{‖ A ‖}^{2}}{{β}_{k}} ) + \\ 4 {C}_{1} {‖ A ‖}^{2} d {β}_{k}^{- 1} {γ}_{k}^{2}\end{matrix} .$$

Total expectation is applied on both sides of the inequality and Jensen's inequality is used to get

$$\begin{matrix}𝔼 [ {F}_{{β}_{k}} ( {\overline{x}}_{k + 1} ) ] - F ( {x}^{*} ) \leq ( 1 - {γ}_{k} ) ( 𝔼 [ {F}_{{β}_{k - 1}} ( {\overline{x}}_{k} ) ] - F ( {x}^{*} ) ) + \\ \frac{{γ}_{k} d}{N} {\sum }_{i = 1}^{N} \sqrt{𝔼 [ {‖ ∇ \overline{F} ( {\overline{x}}_{k} ) - {s}_{k}^{i} ‖}^{2} ]} + \\ \frac{{γ}_{k}^{2}}{2} {d}^{2} ( {L}_{f} + \frac{{‖ A ‖}^{2}}{{β}_{k}} ) + 4 {C}_{1} {‖ A ‖}^{2} d {β}_{k}^{- 1} {γ}_{k}^{2}\end{matrix} .$$

The third term on the right side of the above inequality is focused on.

$$\begin{matrix}\frac{{γ}_{k}^{2}}{2} {d}^{2} ( {L}_{f} + \frac{{‖ A ‖}^{2}}{{β}_{k}} ) = \frac{{γ}_{k}^{2}}{2} {d}^{2} {L}_{f} + \frac{{‖ A ‖}^{2} {d}^{2} {γ}_{k}^{2}}{2 {β}_{k}} \\ = \frac{2 {d}^{2} {L}_{f}}{{( k + 2 )}^{2}} + \frac{2 {‖ A ‖}^{2} {d}^{2} {β}_{0}^{- 1}}{{( k + 2 )}^{\frac{3}{2}}}\end{matrix} .$$

The above equation and the result of Lemma 4 are substituted into the previous inequality to get

$$\begin{matrix}𝔼 [ {F}_{{β}_{k}} ( {\overline{x}}_{k + 1} ) ] - F ( {x}^{*} ) \leq ( 1 - \frac{2}{k + 2} ) ( 𝔼 [ {F}_{{β}_{k - 1}} ( {\overline{x}}_{k} ) ] - F ( {x}^{*} ) ) + \\ \frac{2 {d}^{2} {L}_{f}}{{( k + 2 )}^{2}} + \frac{2 {‖ A ‖}^{2} {d}^{2} {β}_{0}^{- 1}}{{( k + 2 )}^{\frac{3}{2}}} + \frac{16 {C}_{1} {‖ A ‖}^{2} d {β}_{0}^{- 1}}{{( k + 2 )}^{\frac{3}{2}}} + \\ \frac{36 {L}_{f}^{2} {d ( d + 2 {C}_{1} )}^{2} + 24 {C}_{2} d + 12 {C}_{3} d}{{( k + 2 )}^{2}} \\ \leq ( 1 - \frac{2}{k + 2} ) ( 𝔼 [ {F}_{{β}_{k - 1}} ( {\overline{x}}_{k} ) ] - F ( {x}^{*} ) ) + \frac{2 {d}^{2} {L}_{f}}{{( k + 2 )}^{\frac{3}{2}}} + \\ \frac{36 {L}_{f}^{2} {d ( d + 2 {C}_{1} )}^{2} + 12 d ( 2 {C}_{2} + {C}_{3} )}{{( k + 2 )}^{\frac{3}{2}}} + \\ \frac{{‖ A ‖}^{2} {d}^{2} {β}_{0}^{- 1} ( 2 + 16 {C}_{1} )}{{( k + 2 )}^{\frac{3}{2}}}\end{matrix} .$$

If t₀=2, a₁=1, a₂=3/2, A₁=2, and A₂=2d²L_{f}+36L_{f}²d(d+2C₁)²+12d(2C₂+C₃)+∥A∥²d²β₀⁻¹(2+16C₁), the desired result can be obtained according to Lemma 5.

The proof of Theorem 2 is given as follows.

Proof: It can be obtained from

$${G}_{β} ( z ) \leq G ( z ) \leq {G}_{β} ( z ) + \frac{β {L}_{g}^{2}}{2}$$

that

$$G ( A {\overline{x}}_{k + 1} ) \leq {G}_{{β}_{k}} ( A {\overline{x}}_{k + 1} ) + \frac{{β}_{k} {L}_{g}^{2}}{2} = {G}_{{β}_{k}} ( A {\overline{x}}_{k + 1} ) + \frac{{L}_{g}^{2} {β}_{0}}{2 {( k + 2 )}^{\frac{1}{2}}} .$$

$$\frac{1}{N} {\sum }_{i = 1}^{N} 𝔼 [ {F}_{i} ( {\overline{x}}_{k + 1} ) ] - F ( {x}^{*} )$$

is added to both sides of the inequality to get

$$\begin{matrix}𝔼 [ F ( {\overline{x}}_{k + 1} ) ] - F ( {x}^{*} ) = \frac{1}{N} {\sum }_{i = 1}^{N} 𝔼 [ {F}_{i} ( {\overline{x}}_{k + 1} ) ] + G ( A {\overline{x}}_{k + 1} ) - F ( {x}^{*} ) \\ \leq \frac{1}{N} {\sum }_{i = 1}^{N} 𝔼 [ {F}_{i} ( {\overline{x}}_{k + 1} ) ] + {G}_{{β}_{k}} ( A {\overline{x}}_{k + 1} ) - F ( {x}^{*} ) + \frac{{L}_{g}^{2} {β}_{0}}{2 {( k + 2 )}^{\frac{1}{2}}} \\ = 𝔼 [ {F}_{{β}_{k}} ( {\overline{x}}_{k + 1} ) ] - F ( {x}^{*} ) + \frac{{L}_{g}^{2} {β}_{0}}{2 {( k + 2 )}^{\frac{1}{2}}} \leq \frac{{C}_{4} + {L}_{g}^{2} {β}_{0}}{{( k + 2 )}^{\frac{1}{2}}}\end{matrix} .$$

The desired result is obtained.

2. Convergence analysis of stochastic optimization with an indicator function

Although distributed composite stochastic optimization problems with Lipschitz continuous regularization terms are common, there are still many important applications that do not have Lipschitz continuity, so it is necessary to further provide convergence analysis when the nonsmooth part is an indicator function.

Theorem 3: Assume that G: [symbol] ^{p}→ [symbol] is an indicator function with a convex set [symbol] . If

$${η}_{k} = \frac{2}{k + 1} , {β}_{k} = {β}_{0} / {( k + 2 )}^{\frac{1}{2}} ( {β}_{0} > 0 ) , {γ}_{k} = \frac{2}{k + 2} ,$$

and the time decay sequence

$$0 < {ρ}_{k} \leq \frac{d + 2 {C}_{1}}{\sqrt{n} ( k + 2 )} ,$$

according to Assumptions 1-5, for any k≥1,

$$𝔼 [ \overline{F} ( \overline{x} ) ] - \overline{F} ( {x}^{*} ) \leq \frac{{C}_{4}}{{( k + 3 )}^{\frac{1}{2}}} , \\ 𝔼 [ dist ( A {\overline{x}}_{k + 1} , 𝒴 ) ] \leq \frac{‖ {λ}^{*} ‖ {β}_{0} + \sqrt{{‖ {λ}^{*} ‖}^{2} {β}_{0} + 2 {β}_{0} {C}_{4}}}{{( k + 2 )}^{\frac{1}{2}}} ,$$

where λ* is a bounded optimal solution to the dual problem.

Theorem 3 gives upper bounds on the expected suboptimality and the feasibility gap of iterations generated by DSMO-FW with an indicator function. Theorem 3 shows that both the expected suboptimality and the feasibility gap converge to zero at a rate of [symbol] (k^{-1/2}). Considering the Oracle complexity required to find the e-optimal solution, the total number of calls to SFO is

$$𝒪 ( \frac{{( {C}_{4} + ‖ {λ}^{*} ‖ )}^{2}}{{ϵ}^{2}} ) .$$

The proof of Theorem 3 is given as follows.

Proof: Assume that (x*,λ*) is a saddle point of the Lagrangian function [symbol] (x, λ)=F̅(x)+ [symbol] λ, Ax−y [symbol] . It is known from the Lagrangian saddle point theory that for any x∈ [symbol] and y∈ [symbol] ,

$$\begin{matrix}\overline{F} ( {x}^{*} ) \leq ℒ ( x , {λ}^{*} ) = \overline{F} ( x ) + 〈 {λ}^{*} , Ax - y 〉 \\ \leq \overline{F} ( x ) + ‖ {λ}^{*} ‖ ‖ Ax - y ‖\end{matrix} .$$

If x=x̅ₖ₊₁, the expectation of both sides of the above inequality is found to get

$$\begin{matrix}𝔼 [ \overline{F} ( {\overline{x}}_{k + 1} ) ] - \overline{F} ( {x}^{*} ) \geq - 𝔼 [ {min}_{y ∈ 𝒴} ‖ {λ}^{*} ‖ ‖ A {\overline{x}}_{k + 1} - y ‖ ] \\ = - ‖ {λ}^{*} ‖ 𝔼 [ dist ( A {\overline{x}}_{k + 1} , 𝒴 ) ]\end{matrix} .$$

Note that

$${G}_{β} ( Ax ) = {\frac{1}{2 β} [ dist ( Ax , 𝒴 ) ]}^{2} = \frac{1}{2 β} {‖ Ax - {P}_{𝒴} ( Ax ) ‖}^{2}$$

is the Moreau envelope of the indicator function. Therefore, it can be obtained from Theorem 1 that

$$𝔼 [ \overline{F} ( {\overline{x}}_{k + 1} ) ] - \overline{F} ( x \text{*)} \leq 𝔼 [ \overline{F} ( {\overline{x}}_{k + 1} ) ] - \overline{F} ( ( x \text{*)} + \frac{1}{2 {β}_{k}} {𝔼 [ dist ( A {\overline{x}}_{k + 1} , 𝒴 ) ]}^{2} .$$

$$\leq 𝔼 [ {\overline{F}}_{{β}_{k}} ( {\overline{x}}_{k + 1} ) ] - \overline{F} ( {x}^{*} ) \leq \frac{{c}_{4}}{{( k + 3 )}^{\frac{1}{2}}}$$

The first bound in Theorem 3 is obtained. Combine the first bound with the previous inequality to get

$$- ‖ λ * ‖ 𝔼 [ dist ( A {\overline{x}}_{k + 1} , 𝒴 ) ] + \frac{1}{2 {β}_{k}} {𝔼 [ dist ( A {\overline{x}}_{k + 1} , 𝒴 ) ]}^{2} \leq \frac{{c}_{4}}{{( k + 3 )}^{\frac{1}{2}}} .$$

The above inequality is a quadratic inequality about [symbol] [dist(Ax̅ₖ₊₁, [symbol] )]. This inequality can be solved to get the second bound.

The above descriptions are merely preferred embodiments of the present disclosure and are not intended to limit the protection scope of the present disclosure. Any modification, equivalent replacement, and improvement made within the spirit and principle of the present disclosure shall fall within the protection scope of the present disclosure.

What is claimed is:

1. A distributed stochastic nonsmooth optimization method based on smoothing and momentum techniques, wherein in a multi-agent network, each of agents has an individual local objective function, and all the agents aim to find a common strategy for minimizing an average value of all objective functions, the distributed stochastic nonsmooth optimization method based on the smoothing and momentum techniques is configured to optimize and solve parameters of the agents, and the distributed stochastic nonsmooth optimization method based on the smoothing and momentum techniques comprises the following steps:
step 1: performing, by the agents, weighted averaging on state values received from neighbors according to a weighted adjacency matrix of the multi-agent network to obtain an average state estimate;
step 2: obtaining, by the agents, stochastic gradients in each iteration, introducing recursive momentum into a distributed Frank-Wolfe algorithm, and constructing a local gradient iteration approximation;
step 3: estimating, by the agents, a global gradient using a gradient tracking technique; and
step 4: using a Frank-Wolfe step by the agents to compute a conditional gradient and update an iterate;
by performing the steps 1 to 4 iteratively until a number of iterations is greater than a set maximum value, all the agents obtain optimized parameter values.

2. The distributed stochastic nonsmooth optimization method based on the smoothing and momentum techniques according to claim 1, wherein the multi-agent network is:
a network [symbol] =( [symbol] ,ε) comprising N agents [symbol] ={1, 2, . . . , N}, wherein ε represents a set of edges in the network [symbol] ;
each of the agents i∈ [symbol] has an individual local objective function Fᵢ(x)= [symbol] [fᵢ(x, ξⁱ)], wherein fᵢ is a stochastic function involving a strategic variable x∈ [symbol] ^{p} and a random variable ξⁱ with an unknown distribution, [symbol] ^{P} is a p-dimensional real number set;
a function G is a global convex function and has two forms: a Lipschitz continuous nonsmooth function or an indicator function related to a convex set [symbol] ;
the common strategy to be found by all the agents and configured for minimizing the average value of all the objective functions is denoted by x*, wherein x* is a solution of a problem
$${min}_{x ∈ 𝒳} F ( x ) : = \frac{1}{N} {\sum }_{i = 1}^{N} {F}_{i} ( x ) + G ( Ax ) ,$$
wherein [symbol] is a compact convex feasible set and a linear mapping matrix A∈ [symbol] ^{q×n}, [symbol] ^{q×n} is a q×n-dimensional real number set.

3. The distributed stochastic nonsmooth optimization method based on the smoothing and momentum techniques according to claim 1, wherein the distributed stochastic nonsmooth optimization method based on the smoothing and momentum techniques further comprises initializing the following parameters before the step 1:
setting a maximum target number of iterations
$$K = 𝒪 ( \frac{1}{{ε}^{2}} ) ,$$
wherein ε is a predefined convergence error;
initializing the parameters of each of the agents i, wherein the parameters to be optimized x₁ⁱ∈ [symbol] , [symbol] is a feasible set;
initializing a local gradient g₁ⁱ=∇fᵢ(x̅₁ⁱ, ξ₁ⁱ), a first aggregated gradient being y₁ⁱ=g₁ⁱ, wherein i∈ [symbol] , [symbol] ={1, 2, . . . , N}; x1 represents an average state estimate of an i^{th} agent in a first iteration, and ξ₁ⁱ represents a random variable of the i^{th} agent in the first iteration; and
setting a first step size ηₖ∈(0,1] and a second step size γₖ∈(0,1].

4. The distributed stochastic nonsmooth optimization method based on the smoothing and momentum techniques according to claim 2, wherein the step 1 of performing, by the agents, the weighted averaging on the state values received from the neighbors according to the weighted adjacency matrix of the multi-agent network to obtain the average state estimate comprises:
computing, by an 1^{th} agent, an average state estimate x̅ₖⁱ= [symbol] wᵢⱼxₖ^{j} and saving a corresponding data xx in a storage space of the i^{th} agent, wherein [symbol] represents a neighbor set of the i^{th} agent, wᵢⱼ represents an adjacency weight between the i^{th} agent and a j^{th} agent, a weighted adjacency matrix W=[wᵢⱼ]_{N×N} is a doubly stochastic matrix, and k is the number of the iterations.

5. The distributed stochastic nonsmooth optimization method based on the smoothing and momentum techniques according to claim 4, wherein the step 2 of obtaining, by the agents, the stochastic gradients in each iteration, introducing the recursive momentum into the distributed Frank-Wolfe algorithm, and constructing the local gradient iteration approximation comprises:
a constructed local gradient iteration approximation being:
$${g}_{k}^{i} = ( 1 - {η}_{k} ) {g}_{k - 1}^{i} + ∇ {f}_{i} ( {\overline{x}}_{k}^{i} , {ξ}_{k}^{i} ) - ( 1 - {η}_{k} ) ∇ {f}_{i} ( {\overline{x}}_{k - 1}^{i} , {ξ}_{k}^{i} ) ,$$
wherein gₖⁱ is an estimated local gradient of the i^{th} agent in a k^{th} iteration and ηₖ∈(0,1] is a first step size of the k^{th} iteration; and
after computing gₖⁱ, saving a corresponding data gₖⁱ in the storage space of the i^{th} agent.

6. The distributed stochastic nonsmooth optimization method based on the smoothing and momentum techniques according to claim 5, wherein the step 3 of estimating, by the agents, the global gradient using the gradient tracking technique comprises:
repeatedly using, by the i^{th} agent, a first aggregated gradient yₖ₋₁ⁱ obtained in a (k−1)^{th} iteration to get yₖⁱ= [symbol] wᵢⱼyₖ₋₁^{j}+gₖⁱ−gₖ₋₁, sₖ₌ [symbol] _{w}ᵢⱼγₖ^{f} based on the gradient tracking technique, wherein γₖⁱ is a first aggregated gradient of the i^{th} agent in the k^{th} iteration, sₖⁱ is a second aggregated gradient of the i^{th} agent in the k^{th} iteration, and wᵢⱼ represents the adjacency weight between the i^{th} agent and the j^{th} agent;
an estimated global gradient being vₖⁱ=sₖⁱ+βₖ⁻¹A^{T} (Ax̅ₖⁱ−prox_{βk,G}(Ax̅ₖⁱ),
wherein βₖ is a smoothing parameter in the k^{th} iteration and a proximal operator
$${prox}_{{β}_{k} , G} ( A {\overline{x}}_{k}^{i} ) = {argmin}_{z ∈ 𝒳} \{ G ( z ) + \frac{1}{2 {β}_{k}} {‖ A {\overline{x}}_{k}^{i} - z ‖}^{2} \} .$$

7. The distributed stochastic nonsmooth optimization method based on the smoothing and momentum techniques according to claim 6, wherein the step 4 of using the Frank-Wolfe step by the agents to compute the conditional gradient and update the iterate comprises:
a conditional gradient of the i^{th} agent in the k^{th} iteration being zₖⁱ∈
$${argmin}_{ϕ ∈ 𝒳} 〈 {v}_{k}^{i} , ϕ 〉 ;$$
updating an iterate xₖ₊₁ⁱ=x̅ₖⁱ+γₖ(zₖⁱ−x̅ₖⁱ), wherein γₖ∈(0,1] is the second step size of the k^{th} iteration.

8. The distributed stochastic nonsmooth optimization method based on the smoothing and momentum techniques according to claim 2, wherein the distributed stochastic nonsmooth optimization method based on the smoothing and momentum techniques further comprises initializing the following parameters before the step 1:
setting a maximum target number of iterations
$$K = 𝒪 ( \frac{1}{{ε}^{2}} ) ,$$
wherein ε is a predefined convergence error;
initializing the parameters of each of the agents i, wherein the parameters to be optimized x₁ⁱ∈ [symbol] , [symbol] is the compact convex feasible set;
initializing a local gradient g₁ⁱi=∇fᵢ(x̅₁ⁱ, ξ₁ⁱ), a first aggregated gradient being y₁ⁱ=g₁ⁱ, wherein i∈ [symbol] , [symbol] ={1,2, . . . , N}; x̅₁ⁱ represents an average state estimate of an i^{th} agent in a first iteration, and ξ₁ⁱ represents a random variable of the i^{th} agent in the first iteration; and
setting a first step size ηₖ∈(0,1] and a second step size γₖ∈(0,1].

9. The distributed stochastic nonsmooth optimization method based on the smoothing and momentum techniques according to claim 3, wherein the step 1 of performing, by the agents, the weighted averaging on the state values received from the neighbors according to the weighted adjacency matrix of the multi-agent network to obtain the average state estimate comprises:
computing, by the i^{th} agent, an average state estimate x̅ₖⁱ= [symbol] wᵢⱼxₖ^{j} and saving a corresponding data x̅ₖⁱ in a storage space of the i^{th} agent, wherein [symbol] represents a neighbor set of the i^{th} agent, wᵢⱼ represents an adjacency weight between the i^{th} agent and a j^{th} agent, a weighted adjacency matrix W=[wᵢⱼ]_{N×N} is a doubly stochastic matrix, and k is the number of the iterations.

10. The distributed stochastic nonsmooth optimization method based on the smoothing and momentum techniques according to claim 8, wherein the step 1 of performing, by the agents, the weighted averaging on the state values received from the neighbors according to the weighted adjacency matrix of the multi-agent network to obtain the average state estimate comprises:
computing, by the i^{th} agent, an average state estimate x̅ₖⁱ= [symbol] wᵢⱼxₖ^{j} and saving a corresponding data x̅ₖⁱ in a storage space of the i^{th} agent, wherein [symbol] represents a neighbor set of the i^{th} agent, wᵢⱼ represents an adjacency weight between the i^{th} agent and a j^{th} agent, a weighted adjacency matrix W=[wᵢⱼ]_{N×N} is a doubly stochastic matrix, and k is the number of the iterations.

11. The distributed stochastic nonsmooth optimization method based on the smoothing and momentum techniques according to claim 9, wherein the step 2 of obtaining, by the agents, the stochastic gradients in each iteration, introducing the recursive momentum into the distributed Frank-Wolfe algorithm, and constructing the local gradient iteration approximation comprises:
a constructed local gradient iteration approximation being:
$${g}_{k}^{i} = ( 1 - {η}_{k} ) {g}_{k - 1}^{i} + ∇ {f}_{i} ( {\overline{x}}_{k}^{i} , {ξ}_{k}^{i} ) - ( 1 - {η}_{k} ) ∇ {f}_{i} ( {\overline{x}}_{k - 1}^{i} , {ξ}_{k}^{i} ) ,$$
wherein gₖⁱ is an estimated local gradient of the i^{th} agent in a k^{th} iteration and ηₖ ∈(0,1] is a first step size of the k^{th} iteration; and
after computing gₖⁱ, saving a corresponding data gₖⁱ in the storage space of the i^{th} agent.

12. The distributed stochastic nonsmooth optimization method based on the smoothing and momentum techniques according to claim 10, wherein the step 2 of obtaining, by the agents, the stochastic gradients in each iteration, introducing the recursive momentum into the distributed Frank-Wolfe algorithm, and constructing the local gradient iteration approximation comprises:
a constructed local gradient iteration approximation being:
$${g}_{k}^{i} = ( 1 - {η}_{k} ) {g}_{k - 1}^{i} + ∇ {f}_{i} ( {\overline{x}}_{k}^{i} , {ξ}_{k}^{i} ) - ( 1 - {η}_{k} ) ∇ {f}_{i} ( {\overline{x}}_{k - 1}^{i} , {ξ}_{k}^{i} ) ,$$
wherein gₖⁱ is an estimated local gradient of the i^{th} agent in a k^{th} iteration and ηₖ ∈(0,1] is a first step size of the k^{th} iteration; and
after computing gₖⁱ, saving a corresponding data gₖⁱ in the storage space of the i^{th} agent.

13. The distributed stochastic nonsmooth optimization method based on the smoothing and momentum techniques according to claim 11, wherein the step 3 of estimating, by the agents, the global gradient using the gradient tracking technique comprises:
repeatedly using, by the i^{th} agent, a first aggregated gradient yₖ₋₁ⁱ obtained in a (k−1)^{th} iteration to get yₖⁱ= [symbol] wᵢⱼyₖ₋₁^{j}+gₖ−gₖ₋₁, sₖⁱ= [symbol] wᵢⱼyₖ^{j} based on the gradient tracking technique, wherein yₖⁱ is a first aggregated gradient of the i^{th} agent in the k^{th} iteration, sₖⁱ is a second aggregated gradient of the i^{th} agent in the k^{th} iteration, and wᵢⱼ represents the adjacency weight between the i^{th} agent and the j^{th} agent;
an estimated global gradient being vₖⁱ=sₖⁱ+βₖ⁻¹A^{T} (Ax̅ₖⁱ−prox_{βk,G}(Ax̅ₖⁱ),
wherein βₖ is a smoothing parameter in the k^{th} iteration and a proximal operator
$${prox}_{{β}_{k} , G} ( A {\overline{x}}_{k}^{i} ) = {argmin}_{z ∈ 𝒳} \{ G ( z ) + \frac{1}{2 {β}_{k}} {‖ A {\overline{x}}_{k}^{i} - z ‖}^{2} \} .$$

14. The distributed stochastic nonsmooth optimization method based on the smoothing and momentum techniques according to claim 12, wherein the step 3 of estimating, by the agents, the global gradient using the gradient tracking technique comprises:
repeatedly using, by the i^{th} agent, a first aggregated gradient yₖ₋₁ⁱ obtained in a (k−1)^{th} iteration to get yₖⁱ= [symbol] wᵢⱼyₖ₋₁^{j}+gₖⁱ−gₖ₋₁ⁱ, sₖⁱ= [symbol] wᵢⱼyₖ^{j} based on the gradient tracking technique, wherein yₖⁱ is a first aggregated gradient of the i^{th} agent in the k^{th} iteration, sₖⁱ is a second aggregated gradient of the i^{th} agent in the k^{th} iteration, and wᵢⱼ represents the adjacency weight between the i^{th} agent and the j^{th} agent;
an estimated global gradient being vₖⁱ=sₖⁱ+βₖ⁻¹A^{T} (Ax̅ₖⁱ−prox_{βk,G}(Ax̅ₖⁱ),
wherein βₖ is a smoothing parameter in the k^{th} iteration and a proximal operator
$${prox}_{{β}_{k} , G} ( A {\overline{x}}_{k}^{i} ) = {argmin}_{z ∈ 𝒳} \{ G ( z ) + \frac{1}{2 {β}_{k}} {‖ A {\overline{x}}_{k}^{i} - z ‖}^{2} \} .$$

15. The distributed stochastic nonsmooth optimization method based on the smoothing and momentum techniques according to claim 13, wherein the step 4 of using the Frank-Wolfe step by the agents to compute the conditional gradient and update the iterate comprises:
a conditional gradient of the i^{th} agent in the k^{th} iteration being zₖⁱ∈
$${argmin}_{ϕ ∈ 𝒳} 〈 {v}_{k}^{i} , ϕ 〉 ;$$
updating an iterate xₖ₊₁ⁱ=x̅ₖⁱ+γₖ(zₖⁱ−x̅ₖⁱ), wherein γₖ∈(0,1] is the second step size of the k^{th} iteration.

16. The distributed stochastic nonsmooth optimization method based on the smoothing and momentum techniques according to claim 14, wherein the step 4 of using the Frank-Wolfe step by the agents to compute the conditional gradient and update the iterate comprises:
a conditional gradient of the i^{th} agent in the k^{th} iteration being zₖⁱ∈
$${argmin}_{ϕ ∈ 𝒳} 〈 {v}_{k}^{i} , ϕ 〉 ;$$
updating an iterate xₖ₊₁ⁱ=x̅ₖⁱ+γₖ(zₖⁱ−x̅ₖⁱ), wherein γₖ∈(0,1] is the second step size of the k^{th} iteration.
